(19) United States
(12) Patent Application Publication
(10) Pub. No.: US 2021/0174199 A1
(43) Pub. Date: Jun. 10, 2021

(54) CLASSIFYING DOMAIN NAMES BASED ON CHARACTER EMBEDDING AND DEEP LEARNING

(71) Applicant: MICRO FOCUS LLC, Santa Clara, CA (US)

(72) Inventors: Pratyusa K. MANADHATA, Fremont, CA (US); Martin ARLITT, Calgary, CA (US)

(73) Assignee: MICRO FOCUS LLC, Santa Clara, CA (US)

(21) Appl. No.: 16/709,637

(22) Filed: Dec. 10, 2019

(51) Int. Cl. G06N 3/08; G06N 3/04

(52) U.S. Cl. CPC G06N 3/08; G06N 3/0445

(57) ABSTRACT

An apparatus may include a processor that may be caused to access a plurality of known domain names. The processor may be caused to determine a character embedding based on the plurality of known domain names. The character embedding may map each character of a known domain name to a respective vector. The processor may be caused to input the character embedding to a deep learning layer of a neural network. The processor may be caused to access a target domain name to be classified. The processor may be caused to classify the target domain name based on an output of the deep learning layer.

### BACKGROUND

Computer attacks may originate from a malicious domain. For example, a user may unknowingly access a malicious domain that executes phishing attacks to steal user credentials or watering hole attacks to execute arbitrary code in a web browser. To evade detection and blacklisting, attackers may algorithmically generate domain names that may be involved in malicious domains.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that classifies domain names based on a character embedding and deep learning;

FIG. 2 shows a block diagram of an example system for classifying domain names based on a character embedding and deep learning layers;

FIG. 3 depicts a flow diagram of an example method of classifying domain names based on a character embedding and deep learning; and

FIG. 4 depicts a block diagram of an example non-transitory machine-readable storage medium that stores instructions to classify domain names based on a character embedding and deep learning.

FIG. 5 depicts a two-dimensional plot of an example of a learned character embedding of domain names.

FIG. 6 depicts a two-dimensional plot of an example of receiver operating characteristic (ROC) curve for malicious domain name exhibiting high TP rate and low FP rate.

FIG. 7 depicts a two-dimensional plot of an example of a ROC curve for algorithmically-generated benign domain names.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” may be intended to denote at least one of a particular element. As used herein, the term “includes” means includes but not limited to, the term “including” means including but not limited to. The term “based on” means based at least in part on.

To evade detection or “blacklisting” of malicious domain names, malicious actors may algorithmically generate new malicious domain names. However, benign actors such as cloud service providers may also algorithmically generate domain names. As such, merely detecting that a domain name has been algorithmically-generated may not result in positively identifying that domain name as a malicious domain name. Put another way, classifying a domain name as malicious based on a determination that the domain name has been algorithmically-generated may result in false positive identifications. False positive identifications may result in blocking access to legitimate (benign) domains, disrupting legitimate operations for entities that use, for example, cloud services that generate algorithmically-generated benign domain names. Whitelisting such algorithmically-generated benign domain names may result in not catching malicious activity that is also hosted on, for example, cloud services. Furthermore, some detection algorithms may rely on feature identification and curation from expert human operators, which may not scale and may necessitate specialized knowledge that is oftentimes incomplete.

Disclosed herein are apparatuses and methods for classifying domain names by automatically learning a character embedding from domain names and applying the character embedding to a deep learning layer. For example, an apparatus may employ a character embedding layer, a deep learning layer, and a classifier layer. The character embedding layer may learn a character embedding from domain names. The character embedding may reflect similarities of characters in domain name strings. The closer a character is to another character in another domain name, the greater its association and similarly. Thus, the character embedding may reflect similar character structure of one domain name to another domain name. As such, similarly constructed domain names (algorithmically or otherwise) may exhibit similar character structures including particular co-occurrence of characters, which may be reflected in the character embedding.

The deep learning layer may use a Long Short-Term Memory (“LSTM”) architecture, which is an example of a recurrent neural network (“RNN”) that may be suitable for analyzing domain names having variable lengths. The deep learning layer may use the character embedding to learn connections between the character structures of domain names. The deep learning layer may be fully connected to the classifier layer. The classifier layer may make a determination of whether or not a domain name is malicious. In some examples, the classifier layer may include a softmax layer that classifies the domain name into one of multiple classes. In particular examples, the softmax layer may output a respective probability that the domain name belongs to a respective class. The classes may include a malicious class, an algorithmically-generated benign class, and a non-algorithmically-generated benign class. Thus, in these examples, the apparatus may classify a domain name as algorithmically-generated but benign, or non-algorithmically-generated benign. Other classes may be used as well or instead.

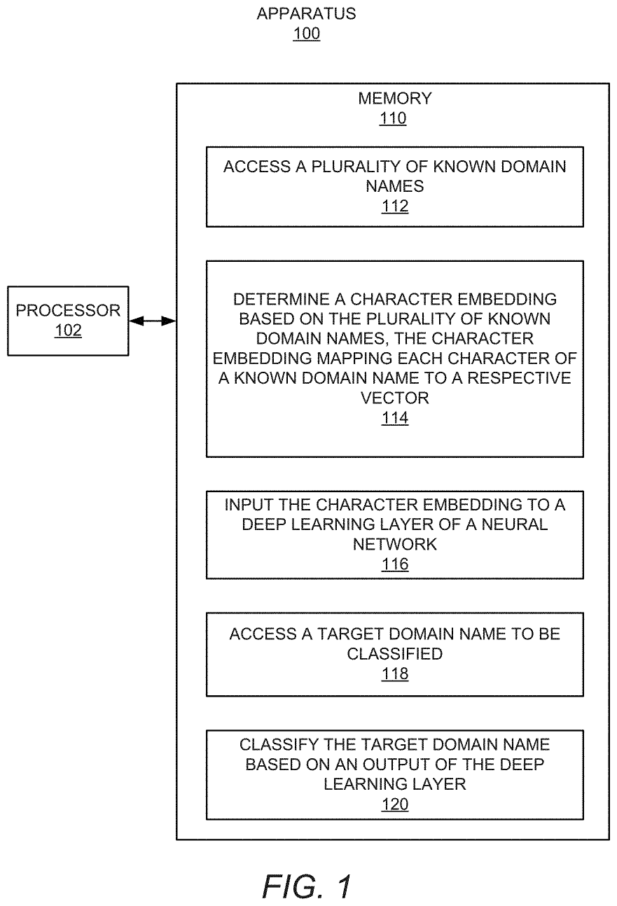

FIG. 1 shows a block diagram of an example apparatus 100 that classifies domain names based on a character embedding and deep learning. It should be understood that the example apparatus 100 depicted in FIG. 1 may include additional features and that some of the features described herein may be removed and/or modified without departing from the scope of the example apparatus 100.

The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scope of the apparatus 100 disclosed herein.

The apparatus 100 may include a memory 110 that may have stored thereon machine-readable instructions (which may also be termed computer readable instructions) 112-120 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals.

Referring to FIG. 1, the processor 102 may fetch, decode, and execute the instructions 112 to access a plurality of known domain names. The known domain names may include domain names known to be malicious (whether or not algorithmically-generated), algorithmically-generated domain names known to be benign, and non-algorithmically-generated domain names known to be benign. The known domain names may be accessed from a database of domain names.

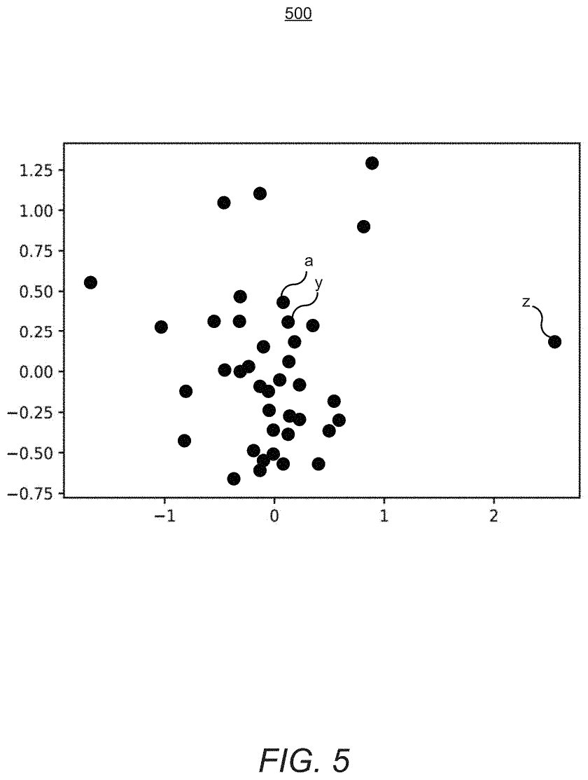

The processor 102 may fetch, decode, and execute the instructions 114 to determine a character embedding based on the plurality of known domain names. Each domain name may be analyzed as a string of characters from which a character embedding is learned. The character embedding may map each character to a respective vector. A vector may refer to a quantitative representation of one or more properties of a character. In some examples, the quantitative representation may be a numeric (such as integer or decimal) representation. In some examples, the numeric representation may be multi-dimensional, which may be aggregated to a single numeric representation. In some examples, a level of similarity between characters may be expressed as a function of their respective vectors. To illustrate, a first character mapped to a first vector may be more similar to a second character mapped to a second vector than to a third vector mapped to a third vector if a difference in value between the first and second vectors is less than a difference in value between the first and third vectors. In other words, a level of similarity of characters may be determined based on a numeric closeness of their respective vectors. Referring to FIG. 5, which depicts a two-dimensional plot of an example of a learned character embedding of domain names, the character “a” may be more similar to “y” than to z based on the learned embedding.

Referring back to FIG. 1, in some examples, the one or more properties may include one or more neighboring characters in a domain name. For example, a given character may be mapped to a vector based on its neighboring characters, such as characters before and/or after the character. In particular, a given character may be mapped to a vector based on its co-occurrence of other characters in the known domain names. Thus, a first character may be closer to a second character in the embedding space when the first and second characters tend to co-occur in the known domain names. The foregoing character embedding may improve the apparatus 100 to detect the character structure of known domain names from which the embedding was learned. For example, based on character-level processing, the apparatus 100 may learn character embeddings for various datasets including algorithmically-generated domain names known to be malicious, algorithmically-generated domain names known to be benign (or safe), and non-algorithmically-generated domain names known to be benign.

To illustrate, a domain generating algorithm may generate malicious domain names by generating a string of characters for the domain name. A given character in the string may be algorithmically-generated based on preceding characters. Likewise, the next character (after the given character in the domain name string) may be dependent on the given character. The learned character embeddings may reflect that, for a given character, there may exist co-occurrence correlations with neighboring characters that depend on the nature of the domain generating algorithms (for domain name datasets known to be algorithmically-generated) or the nature of fixed domain names (for domain name datasets known to be non-algorithmically-generated). By analyzing neighboring characters of domain names for learning character embeddings, the apparatus 100 may detect co-occurrence of characters in domain names. As such, the apparatus 100 may be improved to detect algorithmically-generated domain names based on the character structure of a domain name.

In some examples, the one or more neighboring characters may include N characters that neighbor the character in the known domain name, where N represents a number of characters. Thus, mapping of a character to a vector may be based on the N characters that neighbor the character. In some examples, the one or more neighboring characters may include N continuous characters (such as previous two or more characters and/or next two or more characters).

In some examples, the processor 102 may determine similarities among the N continuous characters with other continuous characters in the plurality of known domain names that neighbor other characters in the plurality of known domain names. In some examples, the processor 102 may, for each character, determine similarities among the N continuous characters that precede the character and the other continuous characters that precede the other characters. In some examples, for each character, the processor 102 may determine similarities among the N continuous characters that follow the character and the other continuous characters that follow the other characters. To illustrate, a benign domain name associated with Domain-based Message Authentication, Reporting & Conformance (“DMARC”) may include the string “_dmarc.” DMARC domain names may exist in a known algorithmically-generated benign domain names database that stores known algorithmically-generated benign domain names. Learned character embeddings from the algorithmically-generated benign domain names database, which include DMARC domain names, may reflect that the characters “_”, “d”, “m”, “a”, “r” and “c” are co-associated with one another. As such, the embeddings may be used to determine that a target domain name that includes the string of characters “_dmarc” will be a DMARC domain name.

The processor 102 may fetch, decode, and execute the instructions 116 to input the character embedding to a deep learning layer of a neural network. The deep learning layer may include an LSTM.

In some examples, the deep learning layer may be trained without manual feature generation. A technical problem faced by some detection approaches is feature engineering. Some machine-learning algorithms may rely on features, manually identified by a domain expert, that indicate a specific class of objects. For example, the presence of a forbidden bigram or trigram in a domain name identified by an expert may indicate that the domain is likely to be malicious in some machine-learning approaches. The identification and refinement of the features is known as feature engineering and a substantial effort may be dedicated to feature engineering in these machine-learning applications. To the extent than an adversary identifies the features used in a detection algorithm via trial and error, then the adversary may evade the detection algorithm.

Instead of generating features by an expert for training purposes, the learned character embeddings may be used to train the deep learning layer to recognize character structures (such as “_dmarc”) as being associated with algorithmically-generated benign domain names or other class of known domain names from which the character embedding was learned.

The processor 102 may fetch, decode, and execute the instructions 118 to access (such as read, obtain, be provided with, or receive) a target domain name to be classified. In some examples, the target domain name to be classified may include a domain name. For example, a device within the local area network may attempt access to the target domain name to be classified, and the apparatus 100 analyze the target domain name for classification in real-time to determine whether or not to permit access to the domain name. In other examples, the apparatus 100 may access the target domain name from an log that logs entries of visited or requested domain names so that the apparatus 100 may add the target domain name to a blacklist or whitelist of domain names based on the classification. The logs may include, for example, query logs from a DNS server, proxy logs from a Web proxy server, firewall logs, and/or other types of logs.

The processor 102 may fetch, decode, and execute the instructions 120 to classify the target domain name based on an output of the deep learning layer. In some examples, an entire string of the target domain name may be classified, and not portions of the target domain name string. In some examples, the processor 102 may not pad domain name strings, facilitating analysis of variable-length domain names. The processor 102 may classify the target domain name by providing the output of the deep learning layer to a classifier layer. In some examples, the classifier layer may include a softmax layer. The softmax layer may determine a first probability that the target domain name is a malicious domain name, a second probability that the target domain name is a non-algorithmically-generated benign domain name, and a third probability that the target domain name is an algorithmically-generated benign domain name. If the domain name's probability of being malicious is more than the other two probabilities, then the domain name is classified as malicious.

In some examples, the processor 102 may compare first character embeddings learned from known malicious domain names (such as algorithmically-generated malicious domain names and/or non-algorithmically-generated malicious domain names) with the character structure of the target domain to determine a first probability that the target domain name is a malicious domain name. Likewise, the processor 102 may compare second character embeddings learned from known non-algorithmically-generated benign domain names with the character structure of the target domain to determine a second probability that the target domain name is a non-algorithmically-generated benign domain name. Still likewise, the processor 102 may compare third character embeddings learned from known algorithmically-generated benign domain names with the character structure of the target domain to determine a third probability that the target domain name is an algorithmically-generated benign domain name. Alternatively, or additionally, other embeddings from other types of known domain names may be learned and used to classify targets domain names as well.

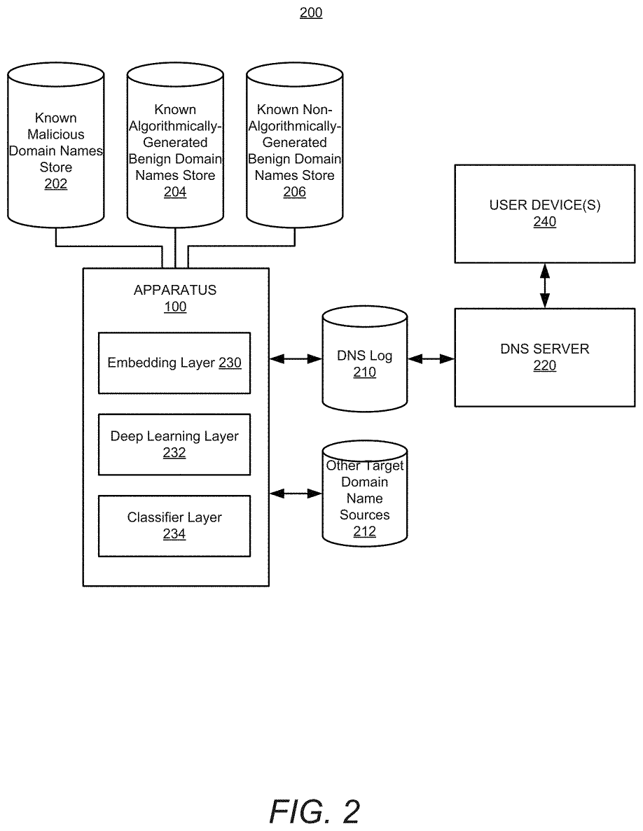

FIG. 2 shows a block diagram of an example system 200 for classifying domain names based on a character embedding and deep learning layers. The apparatus 100 may access known domain names from various sources, such as a known malicious domain names store 202, a known algorithmically-generated benign domain names store 204, a known non-algorithmically-generated benign domain names store 206, and/or other source.

The known malicious domain names store 202 may include algorithmically and/or non-algorithmically-generated domain names, such as the Fraunhofer Domain Generation Algorithms (DGA) data set, the Georgia Tech IMPACT data set, and/or other malicious domain name data sets. The known algorithmically-generated benign domain names store 204 may include domain names from various cloud service providers, such as MICROSOFT AZURE, AMAZON AWS, GOOGLE CLOUD, domains from various internet service providers such as VERIZON, COMCOST, BELLSOUTH, and/or other ISPs, service discovery domains collected from Rapid7, internal data center domains collected from internal data centers, and/or other sources of known algorithmically-generated benign domains. The known non-algorithmically-generated benign domain names store 206 may include static domains known to be benign, such as the AMAZON ALEXA popular domain list, and/or other sources of known non-algorithmically-generated benign domains.

The apparatus 100 may use various layers, such as an embedding layer 230, a deep learning layer 232, a classifier layer 234, and/or other layers to perform machine-learning on the domain names from the various sources and classify target domain names from the Domain Name Server (DNS) log 210 and/or other target domain name sources 212 based on the machine-learning. For example, the various layers may be executed based on, for example, executing instructions by the processor 102 illustrated in FIG. 1.

In some examples, for each of the known domain name data sources, the apparatus 100 may execute the embedding layer 230 to learn a character embedding. For example, the apparatus 100 may execute the embedding layer 230 to learn a first character embedding for domains in the known malicious domain names store 202, a second character embedding for domains in the known algorithmically-generated benign domain names store 204, a third character embedding for the domains in the known non-algorithmically-generated benign domain names store 206, and so forth.

In some examples, the apparatus 100 may input the character embeddings to the deep learning layer 232. The apparatus 100 may execute the deep learning layer 232 to learn parameters of the deep learning layer network, which may be based on relationships between the character embeddings that characterize the domains from which the character embeddings were learned. For example, the apparatus 100 may learn first relationships between characters in domains of the known malicious domain names store 202 based on the first character embedding, learn second relationships between characters in domains of the known algorithmically-generated benign domain names store 204 based on the second character embedding, learn third relationships between characters in domains of the known non-algorithmically-generated benign domain names store 206 based on the third character embedding, and so forth.

The apparatus 100 may generate an output (which may include network parameters in the form of weights assigned to characters) of the deep learning layer 232 and provide the output to the classifier layer 234. The classifier layer 234 may input a target domain name and generate a classification of the target domain name based on the deep learning layer 232. The apparatus 100 may access the target domain name from a DNS log 210 and/or other target domain name sources 212. The DNS log 210 may include a log of domain names from a DNS server 220 that receives requests from user devices 240 for Internet Protocol addresses of domain names. Thus, in some examples, the apparatus 100 may analyze domain names that user devices 240 requested to access.

For example, the classification may be based on a comparison of the character structure of the target domain name to the learned characteristics of the characters from the character embeddings. Such comparison may correlate a level of similarity between the character structure (such as the sequence of characters in a domain name string) and the character embeddings learned from the various domain name sources. For example, the classifier layer 234 may include a softmax layer that may generate a first probability that the target domain name is a malicious domain name based on a level of similarly of the structure of the target domain name and the domains of the known malicious domain names store 202. In some examples, the classifier layer 234 may likewise generate a second probability that the target domain name is an algorithmically-generated benign domain name based on a level of similarly of the structure of the target domain name and the domains of the known algorithmically-generated domain names store 204. In some examples, the classifier layer 234 may further generate a third probability that the target domain name is a non-algorithmically-generated benign domain name based on a level of similarly of the structure of the target domain name and the domains of the known non-algorithmically-generated domain names store 206.

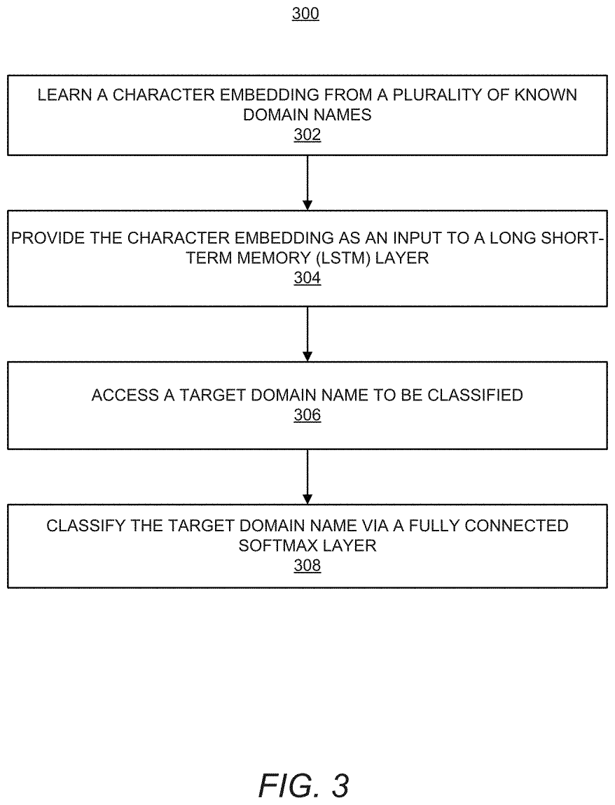

Various manners in which the apparatus 100 may operate to classify domain names are discussed in greater detail with respect to the method 300 depicted in FIG. 3. It should be understood that the method 300 may include additional operations and that some of the operations described therein may be removed and/or modified without departing from the scope of the method 300. The description of the method 300 may be made with reference to the features depicted in FIGS. 1-2 for purposes of illustration.

FIG. 3 depicts a flow diagram of an example method 300 of classifying domain names based on a character embedding and deep learning. At block 302, the processor 102 may learn a character embedding from a plurality of known domain names. In some examples, learning the character embedding comprises determining the character embedding in a reverse direction (for example, output from a downstream, next, layer may be provided as input to a current layer of the RNN). In some examples, learning the character embedding comprises determining the character embedding in a forward direction (for example, output from an upstream, prior, layer may be provided as input to a current layer of the RNN).

At block 304, the processor 102 may provide the character embedding as an input to a Long Short-Term Memory (LSTM) layer. At block 306, the processor 102 may access a target domain name to be classified. At block 308, the processor 102 may classify the target domain name via a fully connected softmax layer. Classifying the target domain may include providing an output of the LSTM to a softmax layer that classifies the target domain into one or more of a plurality of classes. In some examples, the plurality of classes comprises a malicious domain name class, a non-algorithmically-generated benign domain name class, an algorithmically-generated benign domain name class, and/or other classes.

Some or all of the operations set forth in the method 300 may be included as utilities, programs, or subprograms, in any desired computer accessible medium. In addition, the method 300 may be embodied by computer programs, which may exist in a variety of forms. For example, some operations of the method 300 may exist as machine-readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

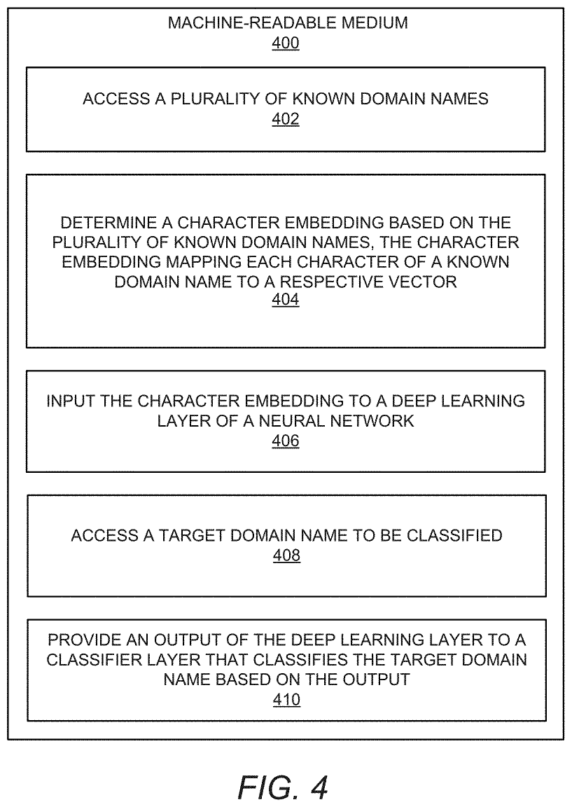

FIG. 4 depicts a block diagram of an example non-transitory machine-readable storage medium 400 that stores instructions to classify domain names based on a character embedding and deep learning. The non-transitory machine-readable storage medium 400 may be an electronic, magnetic, optical, or other physical storage device that includes or stores executable instructions. The non-transitory machine-readable storage medium 400 may be, for example, Random Access memory (RAM), an Electrically Erasable Programmable Read-Only Memory (EEPROM), a storage device, an optical disc, and the like. The non-transitory machine-readable storage medium 400 may have stored thereon machine-readable instructions 402-410 that a processor, such as the processor 102, may execute.

The machine-readable instructions 402 may cause the processor to access a plurality of known domain names. The machine-readable instructions 404 may cause the processor to determine a character embedding based on the plurality of known domain names, the character embedding mapping each character of a known domain name to a respective vector. The machine-readable instructions 406 may cause the processor to input the character embedding to a deep learning layer of a neural network. The machine-readable instructions 408 may cause the processor to access a target domain name to be classified. The machine-readable instructions 410 may cause the processor to provide an output of the deep learning layer to a classifier layer that classifies the target domain name based on the output.

In some examples, the classifier layer may include a softmax layer. In these examples, the machine-readable instructions may cause the processor to classify, based on an output of the softmax layer, the target domain name into one or more of at least: a malicious domain name class, a non-algorithmically-generated benign domain name class, or an algorithmically-generated benign domain name class;

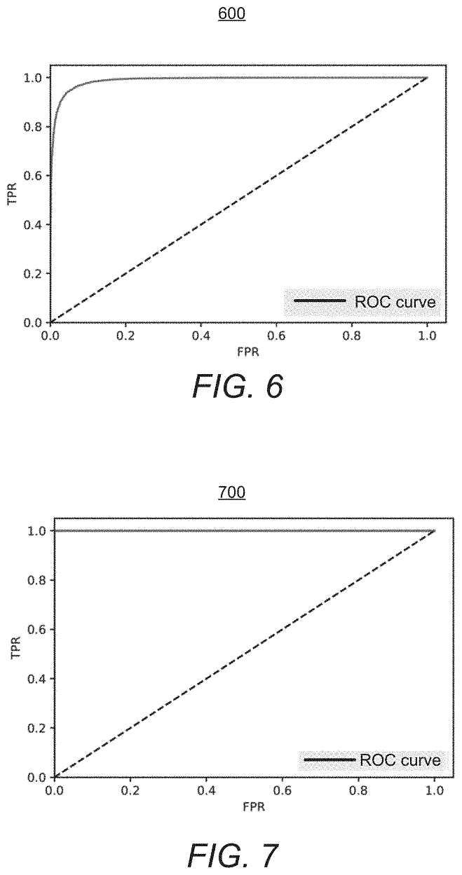

FIG. 5 depicts a two-dimensional plot 500 of an example of a learned character embedding of domain names. Each plot point (dark circles) in plot 500 represents a learned character embedding for a respective character. Only learned character embeddings for characters “a”, “y” and “z” are labeled for illustrative clarity. The plot points may correspond to all characters that were observed in domain name strings that were analyzed. Thus, the plot points may correspond to legal characters that are permitted in domain names. FIG. 6 depicts a two-dimensional plot 600 of an example of receiver operating characteristic (ROC) curve for detecting malicious domains using a one-vs-all approach. FIG. 7 depicts a two-dimensional plot 700 of an example of a ROC curve for detecting algorithmically-generated benign domain names. In plots 600 and 700, the True Positive Rate (TPR) is plotted on the y-axis and the False Positive Rate (FPR) is plotted on the x-axis using a 10-fold cross validation approach.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory machine-readable storage medium on which is stored instructions that when executed by the processor, cause the processor to:
access a plurality of known domain names;
determine a character embedding based on the plurality of known domain names, the character embedding mapping each character of a known domain name to a respective vector;
input the character embedding to a deep learning layer of a neural network;
access a target domain name to be classified; and
classify the target domain name based on an output of the deep learning layer.

2. The apparatus of claim 1, wherein to determine the character embedding, the processor is further caused to:
for each character of the known domain name, identify N continuous characters that neighbor the character in the known domain name, wherein N represents a number of continuous characters.

3. The apparatus of claim 2, wherein the processor is further caused to:
determine similarities among the N continuous characters with other continuous characters in the plurality of known domain names that neighbor other characters in the plurality of known domain names.

4. The apparatus of claim 3, wherein to determine the similarities, the processor is further caused to:
for each character, determine similarities among the N continuous characters that precede the character and the other continuous characters that precede the other characters.

5. The apparatus of claim 3, wherein to determine the similarities, the processor is further caused to:
for each character, determine similarities among the N continuous characters that follow the character and the other continuous characters that follow the other characters.

6. The apparatus of claim 1, wherein the deep learning layer comprises a Long Short-Term Memory (LSTM) layer.

7. The apparatus of claim 1, wherein the processor is further caused to:
provide the output of the deep learning layer to a classifier layer that classifies the target domain name.

8. The apparatus of claim 7, wherein to classify the target domain name, the processor is further caused to:
determine, based on an output of the classifier layer, whether or not the target domain name is associated with a malicious class of domain names.

9. The apparatus of claim 7, wherein the classifier layer comprises a softmax layer that determines a first probability that the target domain name is a malicious domain name, a second probability that the target domain name is a non-algorithmically-generated benign domain name, and a third probability that the target domain name is an algorithmically-generated benign domain name.

10. The apparatus of claim 9, wherein to access the plurality of known domain names, the processor is caused to:
access a first plurality of malicious domain names;
access a second plurality of non-algorithmically-generated benign domain names; and
access a third plurality of algorithmically-generated benign domain names.

11. The apparatus of claim 1, wherein the deep learning layer is trained without manual feature generation.

12. A method, comprising:
learning, by a processor, a character embedding from a plurality of known domain names;
providing, by the processor, the character embedding as an input to a Long Short-Term Memory (LSTM) layer;
accessing, by the processor, a target domain name to be classified; and
classifying, by the processor, the target domain name via a fully connected softmax layer.

13. The method of claim 12, wherein learning the character embedding comprises determining the character embedding in a reverse direction.

14. The method of claim 12, wherein learning the character embedding comprises determining the character embedding in a forward direction.

15. The method of claim 12, wherein classifying the target domain name comprises:
providing an output of the LSTM to a softmax layer that classifies the target domain name into one or more of a plurality of classes.

16. The method of claim 15, wherein the plurality of classes comprises a malicious domain name class, a non-algorithmically-generated benign domain name class, and an algorithmically-generated benign domain name class.

17. A non-transitory machine-readable storage medium on which is stored machine-readable instructions that when executed by a processor, cause the processor to:
access a plurality of known domain names;
determine a character embedding based on the plurality of known domain names, the character embedding mapping each character of a known domain name to a respective vector;
input the character embedding to a deep learning layer of a neural network;
access a target domain name to be classified; and
provide an output of the deep learning layer to a classifier layer that classifies the target domain name based on the output.

18. The non-transitory machine-readable storage medium of claim 17, wherein to determine the character embedding, the machine-readable instructions further cause the processor to:
determine the character embedding in a reverse direction.

19. The non-transitory machine-readable storage medium of claim 17, wherein to determine the character embedding, the machine-readable instructions further cause the processor to:
determine the character embedding in a forward direction.

20. The non-transitory machine-readable storage medium of claim 17, wherein the classifier layer comprises a softmax layer, and wherein the machine-readable instructions further cause the processor to:
classify, based on an output of the softmax layer, the target domain name into one or more of at least: a malicious domain name class, a non-algorithmically-generated benign domain name class, or an algorithmically-generated benign domain name class.
